(19) United States
(12) Patent Application Publication
(10) Pub. No.: US 2024/0071114 A1
(43) Pub. Date: Feb. 29, 2024

(54) IMAGE DATA VERIFICATION

(71) Applicant: Vidatis, LLC, Royse City, TX (US)

(72) Inventors: Jason Wayne Harvey, Royse City, TX (US); Wilhelm Karl Peter Schwerdt, Bensheim (DE); Christopher Bradley Behrens, Kennedale, TX (US); Michael Curtis Jarrett, Brooklyn (YS)

(21) Appl. No.: 18/456,211

(22) Filed: Aug. 25, 2023

Related U.S. Application Data
(60) Provisional application No. 63/373,504, filed on Aug. 25, 2022.

(51) Int. Cl. G06V 20/00; G06V 10/72; G06V 10/75

(52) U.S. Cl. CPC G06V 20/95; G06V 10/72; G06V 10/758

(57) ABSTRACT

Aspects of the present disclosure relate to image data verification. In examples, a discrete cosine transform (DCT) is performed on image data and used to generate a set of DCT coefficients. In some instances, multiple block sizes are used when processing the image data, such that a set of DCT coefficients is generated for each block size. The resulting sets of DCT coefficients for the plurality of block sizes may be processed according to an expected distribution to determine whether the content of the image data is likely to be authentic or likely to be altered, such that an indication may be provided in association with the image data accordingly.

### CROSS-REFERENCE TO RELATED APPLICATION

This application claims priority to U.S. Provisional Application No. 63/373,504, titled “Image Data Verification,” filed on Aug. 25, 2022, the entire disclosure of which is hereby incorporated by reference in its entirety.

### BACKGROUND

Given the ease with which pictures, videos, and other image data may be modified, it can be difficult to discern whether the content therein is authentic or has been altered. These and other issues are further exacerbated by the relatively low barrier to sharing altered or inauthentic content with a large audience (e.g., via social media, electronic messaging applications, and/or the news media).

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to image data verification. In examples, a discrete cosine transform (DCT) is performed on image data and used to generate a set of DCT coefficients. In some instances, multiple block sizes are used when processing the image data, such that a set of DCT coefficients is generated for each block size. The resulting sets of DCT coefficients for the plurality of block sizes may be processed according to an expected distribution to determine whether the content of the image data is likely to be authentic or likely to be altered, such that an indication may be provided in association with the image data accordingly.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for image data verification.

FIG. 2 illustrates an overview of an example method for processing image data to verify the image data according to aspects described herein.

FIG. 3 illustrates an overview of an example method for processing image data using a given block size according to aspects described herein.

FIG. 4 illustrates an overview of an example method for processing image data according to multiple block sizes according to aspects described herein.

FIG. 5 illustrates an example of a suitable operating environment in which one or more aspects of the present application may be implemented.

### DETAILED DESCRIPTION OF THE DRAWINGS

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, image data may be modified to reflect content that is different than when the image data was captured. Examples of image data include, but are not limited to, pictures or videos. For example, the image data may be modified to include additional or different people/objects, remove people/objects, or change one or more associated characteristics (e.g., removing vehicle damage or changing one's facial expression). Further, the prevalence and accessibility of powerful image and/or video editing tools means that even someone of average skill may create relatively convincing altered content in a short amount of time. As a result, it may be difficult to discern whether image data is authentic or has been altered, and, by extension, whether the content depicted therein can be trusted.

Accordingly, aspects of the present disclosure relate to image data verification techniques. In examples, a discrete cosine transform (DCT) is performed on image data and used to generate a set of DCT coefficients. In some instances, multiple block sizes are used when processing the image data, such that a set of DCT coefficients is generated for each block size. For example, a first set of DCT coefficients may be generated for 2×2 blocks of the image data, while a second set of DCT coefficients may be generated for 4×4 blocks of the image data. The resulting sets of DCT coefficients may be processed according to aspects described herein to determine whether the content of the image data is likely to be authentic or likely to be altered, such that an indication may be provided in association with the image data accordingly. It will be appreciated that DCT is provided as an example energy compaction technique and, in other examples, any of a variety of alternative or additional processing may be performed according to aspects described herein. Other examples include, but are not limited to, Wavelets, Fourier Transform, and/or Karhunen-Loewe-Transform/Principal Components Analysis.

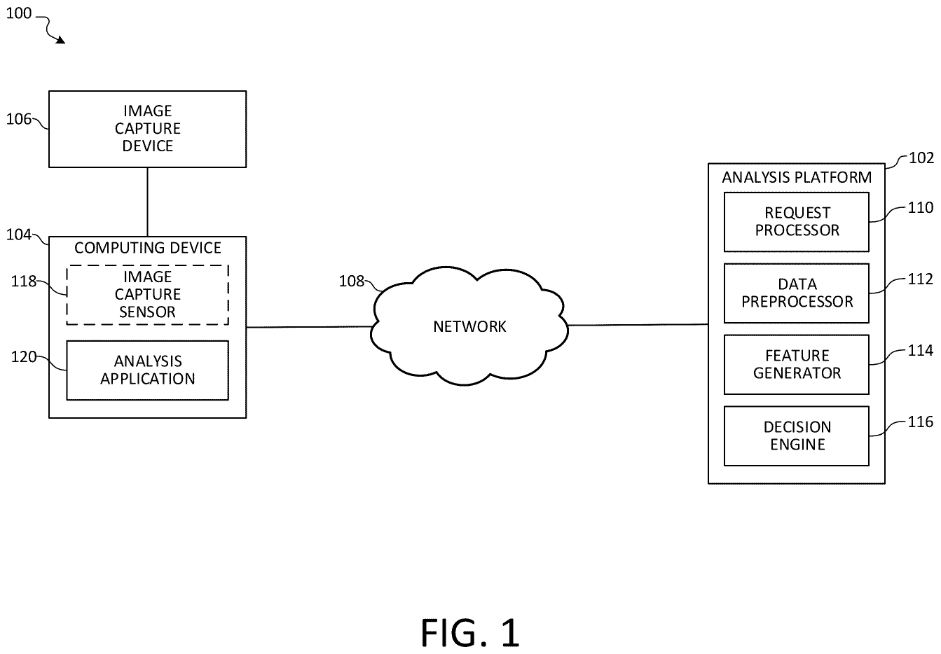

FIG. 1 illustrates an overview of an example system 100 for image data verification. As illustrated, system 100 comprises analysis platform 102, computing device 104, image capture device 106, and network 108. In examples, analysis platform 102 and computing device 104 communicate via network 108. For example, network 108 may comprise a local area network, a wireless network, or the Internet, or any combination thereof, among other examples.

In examples, image capture device 106 is any of a variety of devices, including, but not limited to, a point-and-shoot camera, a digital single-lens reflex (DSLR) camera, a video camera, a drone, a surveillance camera, a traffic camera, or a satellite, among other examples. Image capture device 106 may thus generate image data with which aspects of the present application may be performed. For example, image capture device 106 may generate images and/or one or more frames of video. While image capture device 106 is illustrated as being in communication with computing device 104, image capture device 106 may alternatively or additionally utilize network 108 to communicate in other examples (e.g., with analysis platform 102 and/or computing device 104).

Computing device 104 may be any of a variety of computing devices, including, but not limited to, a mobile computing device, a tablet computing device, a laptop computing device, or a desktop computing device. Computing device 104 is illustrated as comprising analysis application 120 and, optionally, image capture sensor 118. Aspects of image capture sensor 118 may be similar to those discussed herein with respect to image capture device 106 and are therefore not necessarily redescribed. In examples, computing device 104 may obtain image data from image capture device 106 in some examples (e.g., via a wired or wireless connection) or, in other examples, computing device 104 may obtain image data from image capture sensor 118.

While examples are described in which the image data is obtained from an image capture device/sensor, it will be appreciated that image data may be obtained from any of a variety of other sources. For example, a user of computing device 104 may download the image data from a website (not pictured) or other data source to storage of computing device 104 accordingly. As another example, image data may be uploaded or otherwise accessed by analysis platform 102.

In examples, analysis application 120 is used to determine whether the image data is likely to be authentic or altered according to aspects described herein. For example, analysis application 120 may provide at least a part of the obtained image data to analysis platform 102, in response to which a verification indication may be received. In examples, the verification indication comprises an indication that the content of the image data is likely to be authentic or likely to be altered. In some instances, the verification indication further comprises a level of confidence associated with the authenticity determination. As another example, the verification indication may indicate one or more regions of the image data that have been determined to be potentially altered.

Analysis application 120 may display the verification indication to a user of computing device 104. For example, a positive or negative indication may be presented, or the presence or absence of a checkmark or other graphical indicator may indicate authenticity or lack thereof. In examples, the display comprises an indication as to one or more regions that were determined to be potentially altered. It will be appreciated that, in other examples, analysis application 120 may be incorporated into any of a variety of other applications.

In other examples, computing device 104 includes a web browser application (not pictured) that requests verification of image data displayed by the web browser application accordingly. As another example, a website may request verification of image data hosted or otherwise provided by the website. In such examples, analysis platform 102 may provide an application programming interface (API) with which image verification may be performed.

Analysis platform 102 processes image data according to aspects described herein. For example, analysis platform 102 may process image data obtained by image capture device 106 or image capture sensor 118. As another example, analysis platform 102 may process image data otherwise obtained from computing device 104 or any of a variety of other sources. As illustrated, analysis platform 102 includes request processor 110, data preprocessor 112, feature generator 114, and decision engine 116.

Request processor 110 may receive and process requests, as may be generated by analysis application 120 of computing device 104, among other examples. For example, analysis application 120 may provide image data to request processor 110 for processing. Analysis platform 102 may then process the image data (e.g., using data preprocessor 112, feature generator 114, and decision engine 116), such that request processor 110 may provide a verification result in response. As noted above, request processor 110 may implement an API that can be used to provide image data and obtain a verification indication in response.

Data preprocessor 112 may perform any of a variety of preprocessing on image data obtained by analysis platform 102. In examples, data preprocessor 112 changes the color space of the image data, for example to a YCbCr color space (e.g., from an RGB or CMYK color space). In some instances, data preprocessor 112 extracts one or more specific channels from the image data. As an example, data preprocessor 112 may extract the Y or luminance channel, while the Cb and Cr channels may be discarded. In other examples, the Cb and/or Cr channel may be retained for other processing.

While examples are described with respect to specific color spaces and associated channels, it will be appreciated that similar techniques may be used for image data in any of a variety of other color spaces and/or one or more associated channels. Additionally, it will be appreciated that any of a variety of additional or alternative preprocessing operations may be performed by data preprocessor 112 in other examples.

Feature generator 114 generates features that are processed by decision engine 116. In examples, feature generator 114 processes the preprocessed image data (e.g., as may have been generated by data preprocessor 112) to generate a set of DCT coefficients. For instance, the set of DCT coefficients may be generated according to a luminance channel of the preprocessed image data. In some examples, the set of DCT coefficients for the block size at which the image was encoded may be expected to approximately follow Benford's law. Similarly, as block size increases, the degree to which the DCT coefficients follow Benford's law may be expected to have a positive relationship.

According to Benford's law, the probability P of observing a most significant digit d for

base b may be described by the following equation:

$$P ( d ) = {log}_{b} ( 1 + \frac{1}{d} )$$

It will be appreciated that, in other examples, additional or alternative distributions may be used to generate a comparator/baseline with which to perform the processing described herein. For example, a Double Benford distribution may be used (e.g., looking at the two most significant digits) or the following example equation may permit tuning as compared to the above-described Benford distribution. In the equation below, p and q may be used to address data minima or maxima, while N may be used to normalize the resulting distribution.

$$P ( d ) = {log}_{b} ( 1 + \frac{1}{{( p + d )}^{q}} ) \times N$$

In addition to energy compaction (e.g., via DCT, Wavelets, Fourier Transform, and/or Karhunen-Loewe-Transform/Principal Components Analysis), feature generator 114 may perform a log-space transform and/or a frequency-space transform on the resulting DCT coefficients, which may similarly be used for image data verification according to aspects described herein (e.g., by decision engine 116). In examples, feature generator 114 generates one or more expected distributions with which the log-space and/or frequency-space transforms may be compared. For instance, feature generator 114 may generate an expected log distribution and/or an expected Benford or most significant digit (MSD) distribution, respectively.

Use of such expected distributions may enable image data verification even in the absence of reference image data (e.g., comparing authentic vs. altered versions of an image or using device-specific image footprints). For instance, use of an expected Benford distribution may provide a comparator/baseline based on the behavior of natural light. Additionally, since the disclosed processing is, for example, performed based on DCT coefficients, aspects described herein may be agnostic to the format of the image data, such as the JPEG (Joint Photographic Experts Group), Motion JPEG, TIFF (Tag Image File Format), PNG (Portable Network Graphics), HEIC or HEIF (High Efficiency Image File), HEVC (High Efficiency Video Coding), or raw data formats.

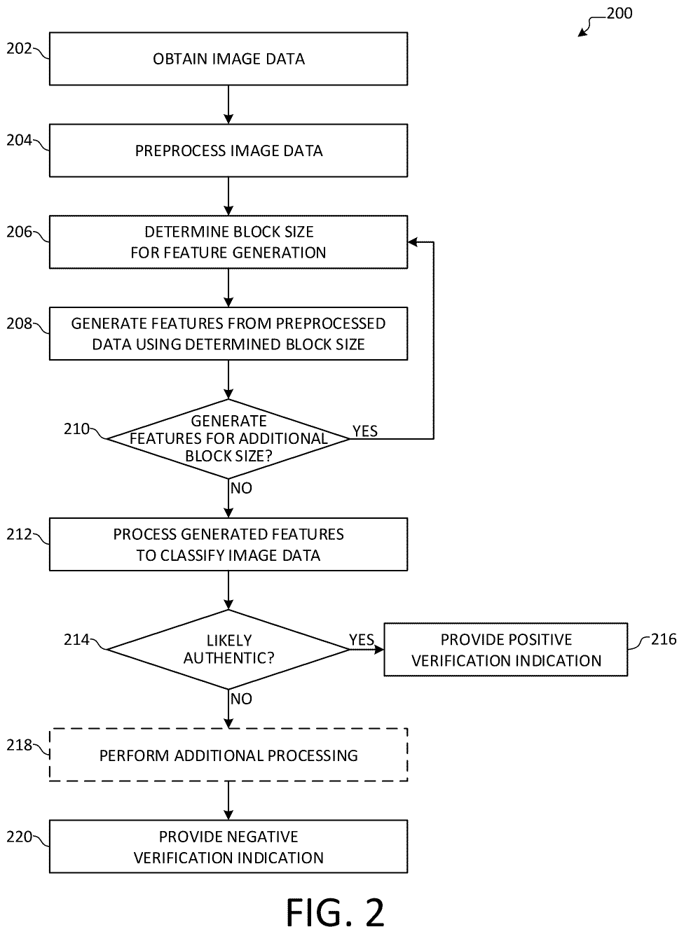

As noted above, feature generator 114 may perform such processing according to multiple block sizes to generate multiple instances of features associated therewith (e.g., generating multiple sets of DCT coefficients, performing multiple transformations, and generating multiple expected distributions). It will thus be appreciated that any of a variety of features may be generated by feature generator 114 according to aspects described herein. Additional examples of such aspects are discussed below with respect to FIGS. 2, 3, and 4.

Analysis platform 102 is further illustrated as including decision engine 116, which processes features (e.g., as may be generated by feature generator 114) to classify image data as being likely authentic or likely altered, among other examples. As an example, decision engine 116 may process the features according to one or more rules and/or thresholds. For instance, decision engine 116 may use one or more relative thresholds and/or thresholds based on a set of statistical characteristics relating to the image data obtained by analysis platform 102, preprocessed data from data preprocessor 112, and/or one or more features generated by feature generator 114, among other examples.

Alternatively, or additionally, decision engine 116 may process the features according to one or more machine learning models. For instance, a machine learning model may be trained based on an annotated training data, where a first set of image data (and/or associated features, as may be generated by feature generator 114) is annotated to indicate it is likely authentic, while a second set of image data (and/or associated features) is annotated to indicate it is likely altered. It will be appreciated that any of a variety of machine learning techniques may be used to yield a classifier with which to classify features associated with a given instance of image data, including, but not limited to, a convolutional neural network, a generative adversarial network (GAN), or reinforcement learning, among other examples.

In some instances, the analysis performed by decision engine 116 may vary depending on the context for which the processing is being performed. For example, in the context of social media, a simple indication of authentic versus altered may be sufficient. In such a context, alterations to the white balance or saturation of the image may not rise to the level of indicating the image has been altered. By contrast, in the context of document authentication (e.g., for a legal proceeding), it may be important to provide more stringent verification and/or a more granular indication of how image data has been altered.

Additionally, in instances where decision engine 116 determines that an image is likely to have been altered, additional processing may be performed. Thus, aspects of the present disclosure may operate as a gateway to more computationally intensive image data analysis, while efficiently identifying authentic images that therefore need not be processed according to the more computationally intensive image processing techniques. Further, it will be appreciated that similar techniques may be used to process one or more frames of a video.

While example feature processing is described, it will be appreciated that additional or alternative processing techniques may be used in other examples. As an example, decision engine 116 may solicit manual user input in some examples, as may be the case when the result of processing the features from feature generator 114 is indeterminate or when manual confirmation of image data alteration is needed.

As noted above, the output of decision engine 116 (e.g., as may be provided to a requestor by request processor 110) may include a verification indication that indicates that the image data is likely authentic or likely altered, an indication of a degree of confidence, and/or one or more non-conforming (e.g., potentially altered) regions of the image data, among other examples. In some instances, decision engine 116 additionally, or alternatively, provides at least a part of the features generated by feature generator 114, thereby enabling a user (e.g., of computing device 104) to make a manual determination as to the authenticity of the image data. Reinforcement learning may be used in such instances, where an indication of such a manual determination may be provided to analysis platform 102 to train or otherwise improve the performance of a machine learning model associated therewith.

While system 100 is illustrated as comprising one computing device 104, one image capture device 106, and one analysis platform 102, it will be appreciated that, in other examples, any number of such elements may be used. Further, it will be appreciated that functionality described above with respect to specific elements of system 100 may be distributed according to any of a variety of other paradigms in other examples. For example, computing device 104 or image capture device 106 may each locally perform at least a part of the processing described above with respect to analysis platform 102. As another example, at least a part of the processing described above with respect to analysis platform 102 may be performed by one or more computing devices of a social media platform or of another website, among other examples.

FIG. 2 illustrates an overview of an example method 200 for processing image data to verify the image data according to aspects described herein. In examples, aspects of method 200 are performed by an analysis platform (e.g., analysis platform 102 in FIG. 1), a computing device (e.g., computing device 104), and/or an image capture device (e.g., image capture device 106).

Method 200 begins at operation 202, where image data is obtained. For example, the image data may be obtained from an image capture device or an image capture sensor, as discussed above with respect to FIG. 1. In other examples, the image data is obtained from a computing device, which may upload or otherwise provide access to the image data accordingly. As another example, the image data may be obtained via an API (e.g., as may be implemented by a request processor, such as request processor 110 in FIG. 1). Thus, it will be appreciated that image data may be obtained in any of a variety of ways.

At operation 204, the image data is preprocessed. For example, the image data may be preprocessed by a data preprocessor, such as data preprocessor 112 of FIG. 1. As noted above, example preprocessing includes, but is not limited to, changing the color space of the image data to YCbCr if necessary and/or extracting the Y channel of the resulting image data, among other examples. It will be appreciated that any of a variety of additional or alternative preprocessing may be performed at operation 204 in other examples.

Flow progresses to operation 206, where a block size is determined for feature generation. In examples, block sizes are iteratively selected, for example starting from a block size of 2×2 and increasing to a maximum block size accordingly (e.g., to 4×4, 8×8, etc.). As another example, the block size is determined from a predetermined set of block sizes, as may be specifically associated with image data having a given size and/or given content therein (e.g., as may be determined according to computer vision and/or object recognition techniques and/or as may be indicated by a user). It will thus be appreciated that any of a variety of block sizes may be used according to aspects described herein.

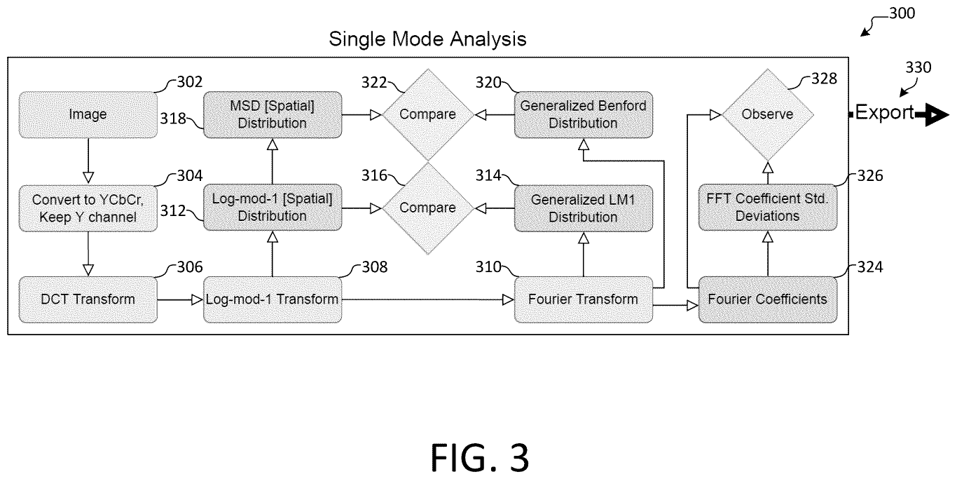

At operation 208, features are generated from the preprocessed image data using the block size that was determined at operation 206. Aspects of operation 208 may be performed by a feature generator, such as feature generator 114 discussed above with respect to FIG. 1, and are therefore not redescribed in detail. Additional examples of such aspects are discussed below with respect to FIG. 3.

Flow progresses to determination 210, where it is determined whether to generate features for an additional block size. For example, the determination may comprise determining whether there are remaining block sizes in the set of block sizes that was evaluated at operation 206. It will be appreciated that any of a variety of additional or alternative criteria may be used in other examples. If it is determined to generate features for an additional block size, flow branches “YES” and returns to operation 206, such that flow may loop between operations 206, 208, and 210 to generate features for multiple block sizes accordingly.

If it is instead determined not to generate features for an additional block size, flow instead branches “NO” to operation 212, where the generated features are processed to classify the image data accordingly. Aspects of operation 212 may be performed by a decision engine, such as decision engine 116 discussed above with respect to FIG. 1, and are therefore not redescribed in detail.

At determination 214, it is determined whether the processing indicates that the image data is likely to be authentic. For example, the rule-, threshold-, and/or machine learning-based processing performed at operation 212 may output a determination or classification that indicates that the image data is likely to be authentic or altered. In examples, an associated confidence level may be generated as well. As another example, a scale (e.g., from 0 to 10 or 0 to 100) may be used, such that a numeric output of operation 212 is compared to a predetermined threshold accordingly. Thus, it will be appreciated that determination 214 may be made according to any of a variety of criteria.

If it is determined that the image data is likely authentic, flow branches “YES” and terminates at operation 216, where a positive verification indication is provided. By contrast, if it is determined that the image data is likely not authentic, flow branches “NO” to operation 218, where additional processing may be performed. In some instances, the additional processing is more computationally intensive and/or has associated user input. As an example, operation 218 may comprise determining the extent to which the image data was altered and/or categorizing the alteration(s), among other examples. Operation 218 is illustrated using a dashed box to indicate that, in some examples, operation 218 may be omitted.

Flow eventually progresses to operation 220, where a negative verification indication is provided. As noted above, the negative verification indication may include one or more regions that are potentially altered. In examples, the negative verification indication further comprises a processing result that was generated at operation 218, among other examples. Method 200 terminates at operation 220.

While examples provided herein are described in instances where a binary verification indication is provided (e.g., positive/negative or likely authentic/altered), it will be appreciated that similar techniques may be used to provide any of a variety of alternative or additional indications. For example, as noted above, a score within a predetermined range may be provided.

FIG. 3 illustrates an overview of an example method 300 for processing image data using a given block size according to aspects described herein. In examples, aspects of method 300 are performed by an analysis platform, such as analysis platform 102 discussed above with respect to FIG. 1.

As illustrated, method 300 begins with image data 302, which may be obtained from an image capture device, an image capture sensor, or from any of a variety of other sources. At operation 304, the color space of the obtained image data is converted to YCbCr and the Y channel is retained. In examples, operation 304 may be performed by a data preprocessor, such as data preprocessor 112. Aspects of operation 304 may be similar to those of operation 204 and are therefore not necessarily redescribed in detail.

Flow progresses to operation 306, where a DCT transform is performed using the Y channel of the preprocessed image data. As noted above, the DCT transform may be performed according to a specified block size. Accordingly, log-mod-1 transform 308 and Fourier transform 310 are performed based on the resulting DCT coefficients. The resulting log-mod-1 distribution 312 is compared to generalized log-mod-1 distribution 314 at determination 316. Similarly, the resulting MSD distribution 318 is compared to a generalized Benford distribution 320 at determination 322. As noted above, any of a variety of alternative or additional distributions may be used in other examples.

In examples, determinations 316 and 322 comprise performing a statistical comparison between distributions 312 and 314, and 318 and 320 (e.g., to determine a degree to which actual distributions 312 and 318 differ from generalized distributions 314 and 320, respectively), such as evaluating a statistical distance between the actual and generalized distributions. It will be appreciated that any of a variety of additional or alternative techniques may be used in other examples. As noted above, generalized distributions 314 and 320 enable the processing of actual distributions 312 and 318 to evaluate authenticity without the use of reference image data and/or a library of reference fingerprints.

Fourier coefficients 324 that result from Fourier transform 310 are used to generate standard deviations 326, both of which are processed at determination 328. Determination 328 may comprise an evaluation of the degree to which the Fourier transform coefficients 324 are noisy and/or “spikey.” Export arrow 330 is provided to indicate that the resulting features (e.g., as may result from determinations 316, 322, and/or 328) are processed by a decision engine according to aspects described herein.

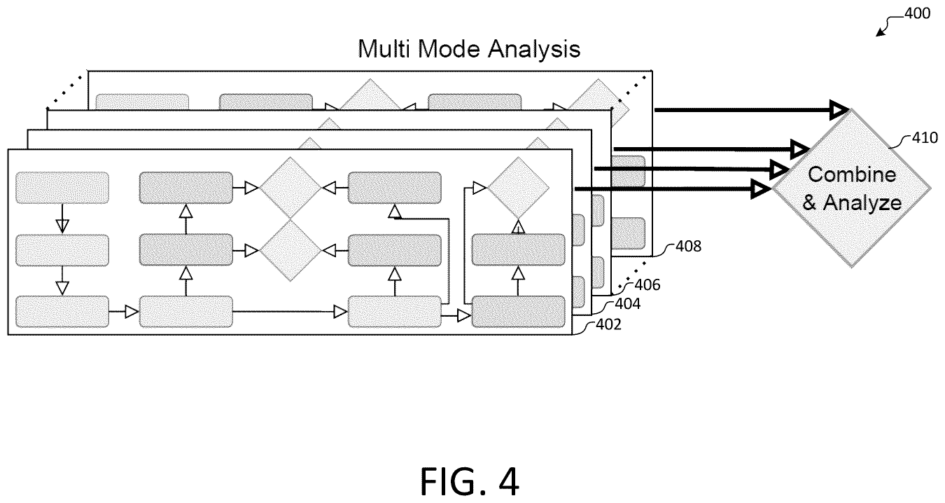

FIG. 4 illustrates an overview of an example method 400 for processing image data according to multiple block sizes according to aspects described herein. As illustrated, method 400 includes instances 402, 404, 406, and 408 of feature generation at a specific block size according to aspects described herein. Aspects of instances 402, 404, 406, and 408 may be similar to those discussed above with respect to operations 206, 208, and 210 of FIG. 2, as well as method 300 in FIG. 3. For instance, such processing may be performed by a feature generator, such as feature generator 114 in FIG. 1.

The resulting sets of features are then processed at determination 410, aspects of which may be similar to operations 212, 214, 216, 218, and 220 discussed above with respect to FIG. 2. For example, aspects of determination 410 may be performed by a decision engine, such as decision engine 116 in FIG. 1.

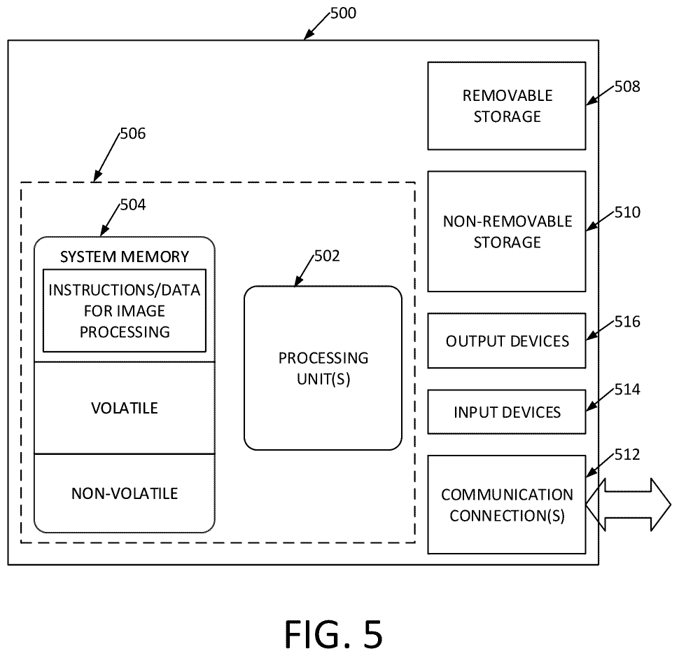

FIG. 5 illustrates an example of a suitable operating environment 500 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 500 typically may include at least one processing unit 502 and memory 504. Depending on the exact configuration and type of computing device, memory 504 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as a keyboard, mouse, pen, voice input, etc. and/or output device(s) 516 such as a display, speakers, printer, etc. Also included in the environment may be one or more communication connections, 512, such as LAN, WAN, point to point, etc.

Operating environment 500 may include at least some form of computer readable media. The computer readable media may be any available media that can be accessed by processing unit 502 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 504. While executing on the processing unit 502, program modules (e.g., applications, Input/Output (I/O) management, and other utilities) may perform processes including, but not limited to, one or more of the stages of the operational methods described herein such as the methods discussed with respect to FIG. 1, 2, 3, or 4, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 500 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
obtaining image data;
preprocessing the image data to generate preprocessed image data;
generating, using the preprocessed image data, a set of features for each block size of a plurality of block sizes;
processing the generated sets of features to determine whether the image data is authentic; and
when it is determined that the image data is authentic, providing a positive verification indication for the obtained image data.

2. The system of claim 1, wherein preprocessing the image data comprises performing at least one of:
converting a color space of the image data to YCbCr; or
extracting the Y channel of the image data.

3. The system of claim 1, wherein generating the set of features for each block size comprises:
generating a set of discrete cosine transform (DCT) coefficients for the block size; and
comparing the DCT coefficients to an expected distribution.

4. The system of claim 1, wherein processing the generated sets of features is performed using at least one of:
a set of rules;
a set of thresholds; or
a machine learning model trained according to a first set of image data annotated as authentic and a second set of image data annotated as altered.

5. The system of claim 1, wherein:
the image data is obtained as a request that is received via an application programming interface (API); and
the positive verification indication is provided, via the API, in response to the request.

6. The system of claim 1, wherein the set of operations further comprises:
when it is determined that the image data is not authentic, performing additional processing of the image data.

7. The system of claim 1, wherein the image data is obtained from a remote computing device.

8. A method for processing image data to determine whether the image data is authentic, the method comprising:
preprocessing the image data to extract luminance data from the image data;
generating, using the luminance data, a set of features for each block size of a plurality of block sizes;
processing the generated sets of features to determine whether the image data is authentic; and
when it is determined that the image data is authentic, providing a positive verification indication for the image data.

9. The method of claim 8, wherein preprocessing the image data comprises:
converting a color space of the image data to YCbCr; and
extracting the Y channel of the image data as the luminance data.

10. The method of claim 8, wherein generating the set of features for each block size comprises:
generating a set of discrete cosine transform (DCT) coefficients for the block size; and
comparing the DCT coefficients to an expected distribution.

11. The method of claim 8, wherein processing the generated sets of features is performed using at least one of:
a set of rules;
a set of thresholds; or
a machine learning model trained according to a first set of image data annotated as authentic and a second set of image data annotated as altered.

12. The method of claim 8, wherein the set of operations further comprises:
when it is determined that the image data is not authentic, performing additional processing of the image data.

13. The method of claim 8, wherein obtaining the image data comprises obtaining the image data from a remote computing device.

14. A method for processing image data to determine whether the image data is authentic, the method comprising:
obtaining image data;
preprocessing the image data to generate preprocessed image data;
generating, using the preprocessed image data, a set of features for each block size of a plurality of block sizes;
processing the generated sets of features to determine whether the image data is authentic; and
when it is determined that the image data is authentic, providing a positive verification indication for the obtained image data.

15. The method of claim 14, wherein preprocessing the image data comprises performing at least one of:
converting a color space of the image data to YCbCr; or
extracting the Y channel of the image data.

16. The method of claim 14, wherein generating the set of features for each block size comprises:
generating a set of discrete cosine transform (DCT) coefficients for the block size; and
comparing the DCT coefficients to an expected distribution.

17. The method of claim 14, wherein processing the generated sets of features is performed using at least one of:
a set of rules;
a set of thresholds; or
a machine learning model trained according to a first set of image data annotated as authentic and a second set of image data annotated as altered.

18. The method of claim 14, wherein:
the image data is obtained as a request that is received via an application programming interface (API); and
the positive verification indication is provided, via the API, in response to the request.

19. The method of claim 14, wherein the set of operations further comprises:
when it is determined that the image data is not authentic, performing additional processing of the image data.

20. The method of claim 14, wherein the image data is obtained from a remote computing device.
